(19) United States
(12) Patent Application Publication
(10) Pub. No.: US 2007/0108279 A1
(43) Pub. Date: May 17, 2007

(54) Unfold smart-card card reader

(75) Inventor: Pen-Lo Wang, Longtan Township (TW)

Correspondence Address: TROXELL LAW OFFICE PLLC, SUITE 1404, 5205 LEESBURG PIKE, FALLS CHURCH, VA, 22041, US

(73) Assignee: A-Men Technology Corporation

(21) Appl. No.: 11/271,795

(22) Filed: Nov. 14, 2005

(51) Int. Cl. G06K 7/06

(52) U.S. Cl. 235/441

(57) ABSTRACT

An unfold smart-card card reader includes a main body, which has a computer connector at a front end thereof and an insertion slot at a rear end thereof. The insertion slot has an integrated circuit card connector provided with a sensor. The main body is disposed with symmetrical left wing and right wing at two sides of the insertion slot. The left wing and right wing each has one side thereof connected to the main body respectively using rotational axes, thereby allowing the left wing and the right wing to perform stretching or withdrawing movements relative to the main body, enabling a smart card to be placed via the insertion slot into the main body. Data stored at an integrated circuit of the smart card are accessed by the sensor in the main body, and transmitted for further applications via the computer connector.

### BACKGROUND OF THE INVENTION

(a) Field of the Invention The invention relates to an unfold smart-card card reader, and more particularly, to a smart-card card reader having an appealing appearance as well as simple operations.

(b) Description of the Prior Art

Accompanied with social advancement, various smart cards have rapidly developed. These smart cards include credit cards and cash-in-advance cards that have reached maturity in practical applications; and identification cards, student cards and certification cards that have been extensively spread by government and private corporations, and successfully being used.

Since applications of the aforesaid smart cards are quite popular nowadays, applications of card readers have also made great progress. More especially in an Internet-dominant era as it is today, a diversity of transactions and services can be completed with a simple click through the Internet by connecting to a computer via a card reader. Not only operations are simple, but also card readers are capable of providing more ideal security compared to common online transactions using security configurations thereof.

However, structures of card readers relatively lack enhancement considering huge advancement of smart card technologies. For instance, current card readers are provided with slots and related electric circuits, but not satisfactory locating devices. A common smart card is generally a card placed with an integrated circuit without locating effects. Therefore, when inserting a smart card into a card reader, failure in accessing data is often resulted from inappropriate positions, and inserting the card repeatedly must be performed to activate operations. In addition, a card reader is not used on regular basis. A prior card reader with a dull appearance provides inadequate convenience in usage, and a container is often required when the card reader is not in use to frequently lead to predicaments that the card reader cannot be timely found when needed.

In view of the aforesaid shortcomings of the prior card reader, it is a vital task of the invention as how to provide a card reading device having an appealing appearance and simple operations for promoting applications and development of smart cards.

### SUMMARY OF THE INVENTION

The primary object of the invention is to provide an unfold smart-card card reader having an appealing appearance using designs such as insects or birds with spread wings. In addition, the wings can be utilized for locating a smart card in coordination with practical operations, thereby facilitating data access while also offering esthetical as well as practical values.

Another object of the invention is to provide an unfold smart-card card reader having simple operations and accurate positioning effects, such that a user is allowed to access data in a smart card for further applications without having to repeatedly inserting and unplugging the smart card.

The other object of the invention is to provide an unfold smart-card card reader having an appealing appearance that it may serve as a household ornament when not in use without undesirably occupying space.

According to the invention, an unfold smart-card card reader for accomplishing the aforesaid objects comprises a main body, which has a computer connector at a front end thereof, with the computer connector being Universal Serial Bus (USB) or IEEE1394, and an insertion slot at a rear end thereof, with the insertion slot being placed with an integrated circuit connector having a sensor; and a left wing and a right wing each having a side thereof connected to the main body respectively using a rotational axis. Using the rotational axes, the left wing and the right wing are enabled to stretch or withdraw relative to the main body. To put the aforesaid structures to application, the left wing and the right wing are stretched relative to the main body, and a smart card is inserted via the insertion slot into and located in the main body. Data stored at an integrated circuit of the smart card are accessed by the sensor in the main body, and transmitted for further applications via the computer connector.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view according to the invention.

FIG. 2 shows an exploded elevational view according to the invention.

FIG. 3 shows a planar view according to the invention.

FIG. 4 shows a planar motional schematic according to the invention.

FIG. 5 shows another embodiment according to the invention.

### DETAILED DESCRIPTION OF THE PREFERRED EMBODIMENTS

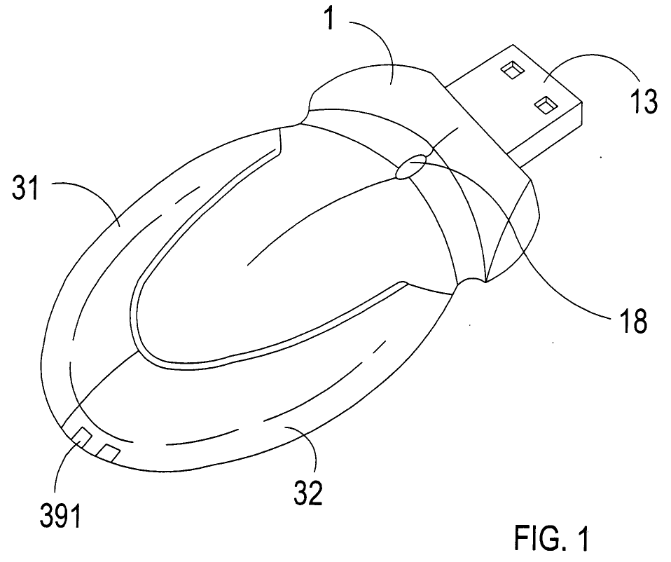

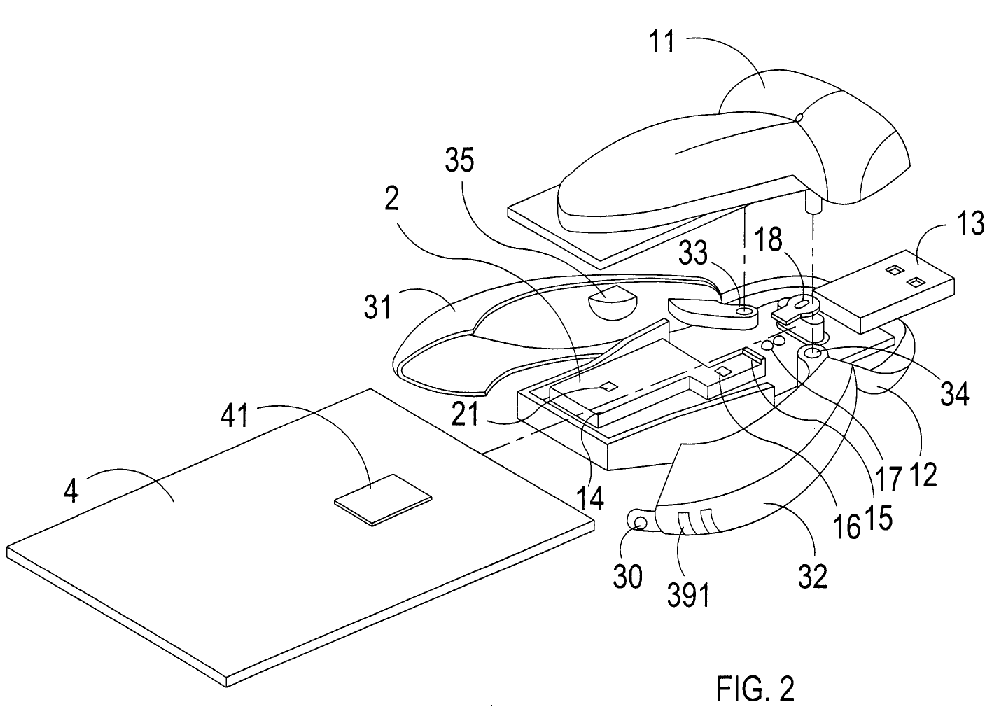

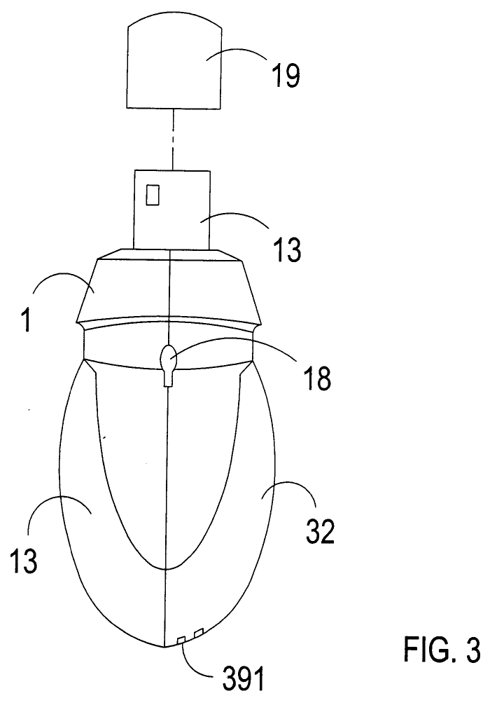

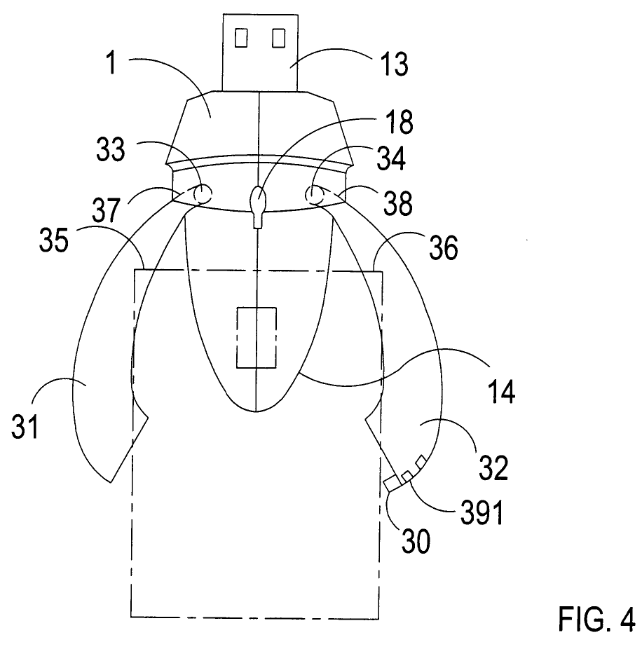

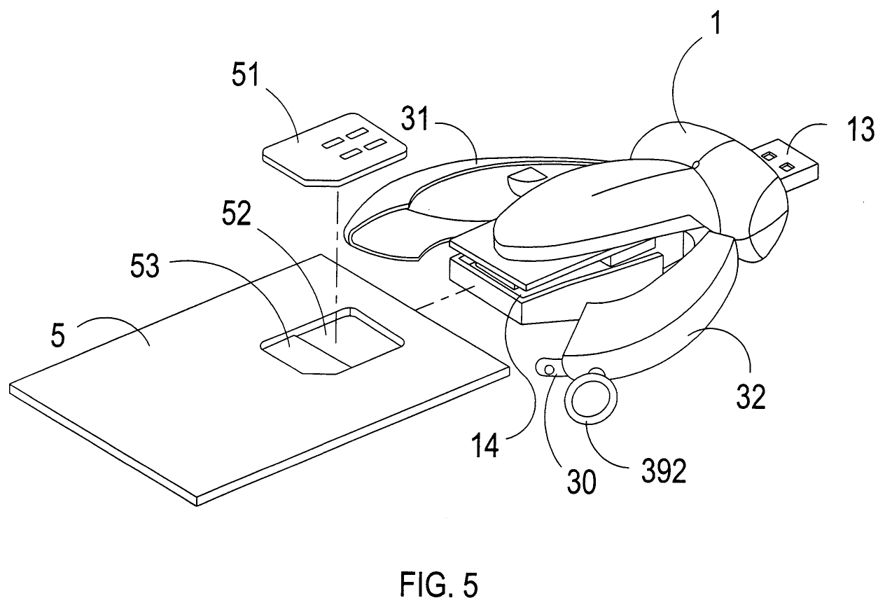

Referring to FIG. 1 to FIG. 5, an unfold smart-card card reader according to the invention comprises:

a main body 1 consisted an upper cover 11 and a lower cover 12; and having a computer plug 13 at a front end thereof, wherein the computer plug 13 may be a universal serial bus (USB), IEEE1394 or other connecting plug, and an insertion slot 14 at a rear end thereof for guiding in a smart card 4;

an integrated circuit connector 2 provided in the insertion slot 14, and having a sensor 21 for accessing data in a smart-card integrated circuit 41 inserted into the insertion slot 14, with the data being further transmitted to a computer (not shown) through circuits of the connector 2 via the computer plug 13; and

a pair of symmetrical left wing 31 and right wing 32, each having one side thereof connected to the main body 1 respectively using rotational axes 33 and 34, wherein, the left wing 31 and the right wing 32 can be stretched or withdrawn relative to the main body 1 using the rotational axes 33 and 34, respectively; and fastening devices 30 at edges of the left wing 31 and the right wing 32 for locating the left wing 31 and the right wing 32 when the left wing 31 and the right wing 32 are drawn close to each other.

Using the aforesaid structures, the invention provides a practical card reader having an appealing appearance. When stretched, the left wing 31 and the right wing 32 look like an insect soaring with wings thereof stretched; when withdrawn, the left wing 31 and the right wing 32 look like an insect in dormancy, thereby offering delights to card reading operations originally considered as rather monotonous. In addition, the invention also serves as an ornament in a house or office to add esthetical values when not in use.

Apart from the aforesaid standard-sized smart card 4, a standard-sized conversion card 5 may be used for applications of a smaller-sized subscriber identity model (SIM) card 51. The SIM card 51 is placed into the conversion card 5 to similarly perform data access.

For usage convenience, the left wing 31, the right wing 32 and the insertion slot 14 have interiors thereof respectively disposed with limiting edges 35, 36 and 15 for locating positions of the smart card 4 placed therein. The smart card 4 is directly located using the limiting edges 35, 36 and 15 to further provide usage convenience. The rotational axes 31 and 34 of the left wing 31 and the right wing 32 are provided with locating edges 37 and 38. The locating edges 37 and 38 may be butted against the main body 1 when the left wing 31 and the right wing 32 are stretched to restrict stretched breadths of the left wing 31 and the right wing 32, while also locating the limiting edges 37 and 38 of the left wing 31 and the right wing 32. Moreover, the insertion slot 14 may be provided with a limiting switch 16 therein for detecting whether the smart card 4 is placed therein to further determine whether to activate card accessing. The main body 1 has a light-emitting body 17 therein, and a light-transmissive lid 17 at a position at a housing of the main body 1 corresponding to the light-emitting body 17. When the smart card 4 is inserted, the light-emitting body 17 is activated and illuminated using the limiting switch 16, and is shown through the light-transmissive lid 18 to notify a user that the device is performing normal operation.

Furthermore, outer sections of the left wing 31 or the right wing 32 may be provided with suspension openings 391 or suspension loops 392, which can be inserted by a thread to offer a user with portability. The computer connector 13 may have an exterior thereof provided with a protection cover 19 for protecting the computer connector 13. However, these devices are prior inventions and shall not be unnecessarily described.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An unfold smart-card card reader comprising:
a main body having a computer plug at a front end thereof, and an insertion slot at a rear end thereof;
a left wing and a right wing symmetrically disposed at two sides of the main body, and each having one side thereof axially provided at the main body for performing stretching or withdrawing movements relative to the main body; and
an integrated circuit connector placed in the insertion slot of the main body, having a sensor, and being used for accessing data at an integrated circuit of a smart card inserted into the insertion slot.

2. The unfold smart-card card reader in accordance with claim 1, wherein the main body is consisted of an upper cover and a lower cover.

3. The unfold smart-card card reader in accordance with claim 1, wherein the insertion slot is provided with a limiting switch therein for detecting positions of a smart card placed in to further determine whether or not to activate the device.

4. The unfold smart-card card reader in accordance with claim 1, wherein corresponding inner sides of the left wing and the right wing and an interior of the insertion slot are devised with limiting edges for locating positions of a smart card placed therein.

5. The unfold smart-card card reader in accordance with claim 1, wherein rotational axes of the left wing and the right wing are provided with locating edges, which are butted against the main body when the left wing and the right wing are stretched, thereby limiting stretched breadths of the left wing and the right wing.

6. The unfold smart-card card reader in accordance with claim 1, wherein edges of the left wing and the right wing are provided with fastening devices for locating purposes when the left wing and the right wing are drawn close to each other.

7. The unfold smart-card card reader in accordance with claim 1, wherein the main body has a light-emitting body therein, and a light-transmissive lid at a position at a housing of the main body corresponding to the light-emitting body, thereby indicating a smart card being inserted by illuminating the light-emitting body.

8. The unfold smart-card card reader in accordance with claim 1, wherein the left wing or the right wing has outer sections thereof provided with suspension openings or suspension loops for a thread to inserted through.

9. The unfold smart-card card reader in accordance with claim 1, wherein the computer connector is a Universal Serial Bus (USB) or an IEEE1394 plug.

10. The unfold smart-card card reader in accordance with claim 1, wherein the computer connector is covered by a protection cover.
